(19) United States
(12) Patent Application Publication
(10) Pub. No.: US 2026/0200515 A1
(43) Pub. Date: Jul. 16, 2026

(54) SPOOL SUPPORT ASSEMBLY FOR A UTILITY CART

(71) Applicant: Apex Brands, Inc., Apex, NC (US)

(72) Inventors: Jesse HIGGINS, Raleigh, NC (US); Robert WARREN, Charlotte, NC (US); Zhihong FU, Cary, NC (US); Kyle ROMANICK, Fuquay-Varina, NC (US); Andrew SPECIALE, Raleigh, NC (US)

(21) Appl. No.: 19/137,013

(22) PCT Filed: Dec. 4, 2023
(86) PCT No.: PCT/US2023/082272

§ 371 Date: Jun. 9, 2025

Related U.S. Application Data
(60) Provisional application No. 63/431,845, filed on Dec. 12, 2022.
(60) Provisional application No. 63/468,565, filed on May 24, 2023.

(51) Int. Cl. B62B 3/02; B62B 3/10; B65H 75/02

(52) U.S. Cl. CPC B62B 3/02; B62B 3/104; B65H 75/02

(57) ABSTRACT

A utility cart may include a handle, a top support platform, to which the handle may be operably coupled, a bottom support platform which may be parallel to the top support platform, a plurality of upright support members which may operably couple the bottom support platform to the top support platform, a mobility assembly which may be operably coupled to the bottom support platform, and a spool support assembly which may be removably operably coupled to the utility cart. The spool support assembly may be configured to rotatably support one or more spools such that the one or more spools may have freedom to rotate relative to the spool support assembly.

### TECHNICAL FIELD

Example embodiments generally relate to utility carts and, in particular, relate to utility carts that are provided with a spool support assembly for improved utility and versatility.

### BACKGROUND

Utility carts may be commonly used in various settings ranging from dedicated workspaces such as labs, garages, and warehouses or other storage facilities to miscellaneous settings such as in offices, homes, restaurants, and many more. Within the various settings that utility carts may be used, utility carts may also be used for various purposes including but not limited to transporting objects, storing objects, working on objects, displaying objects, and many more. Utility carts may essentially be ubiquitously used in any sort of productive setting involving objects that may be desirable to transport due to their widely applicable and often simple design allowing the cart to be a useful resource in a large amount of use cases.

Existing utility carts may be rather simplistic and outdated in their design considering how they have come to be commonly used today. In this regard, users of utility carts may be using utility carts for more, and different, tasks than in the past. As such, there may be a need to develop an improved design for a utility cart that may be better suited for the increasingly wide variety of tasks for which utility carts may be utilized.

### BRIEF SUMMARY OF SOME EXAMPLES

Some example embodiments may provide for a utility cart. The utility cart may include a handle, a top support platform, to which the handle may be operably coupled, a bottom support platform which may be parallel to the top support platform, a plurality of upright support members which may operably couple the bottom support platform to the top support platform, a mobility assembly which may be operably coupled to the bottom support platform, and a spool support assembly which may be removably operably coupled to the utility cart. The spool support assembly may be configured to rotatably support one or more spools such that the one or more spools may have freedom to rotate relative to the spool support assembly.

Some example embodiments may provide for an accessory support assembly for a utility cart. The accessory support assembly may include a handle, a top support platform of the utility cart, a bottom support platform of the utility cart, the bottom support platform may be disposed substantially parallel to the top support platform, a plurality of upright support members which may operably couple the bottom support platform to the top support platform, and a spool support assembly which may be removably operably coupled to the utility cart. The spool support assembly may be configured to rotatably support one or more spools such that the one or more spools may have freedom to rotate relative to the spool support assembly.

Some example embodiments may provide for a spool support assembly for removable operable coupling to a utility cart. The spool support assembly may include a first post member which may be operably coupleable to a top support platform of the utility cart via a first accessory slot which may be formed at a perimeter of the top support platform, a second post member which may be operably coupleable to the top support platform via a second accessory slot which may be formed at the perimeter of the top support platform, the second post member may be disposed on an opposing side of the top support platform relative to the first post member, and a cross rod which may extend laterally across a width of the top support platform and may be disposed between the first post member and the second post member to support the one or more spools. The spool support assembly may be configured to support the plurality of spools above the top support platform.

### BRIEF DESCRIPTION OF THE SEVERAL VIEWS OF THE DRAWING(S)

Having thus described some example embodiments in general terms, reference will now be made to the accompanying drawings, which are not necessarily drawn to scale, and wherein:

FIG. 1 illustrates a perspective view of a utility cart according to an example embodiment;

FIG. 2 illustrates a perspective view of the utility cart having multiple spool support assemblies according to an example embodiment;

FIG. 3 illustrates a perspective view of the utility cart having a spool support assembly according to an example embodiment;

FIG. 4 illustrates a perspective view of the utility cart having the spool support assembly according to an example embodiment;

FIG. 5 illustrates a front view of the utility cart having the spool support assembly according to an example embodiment;

FIG. 6 illustrates a side view of the utility cart having the spool support assembly according to an example embodiment;

FIG. 7 illustrates a closer up perspective view of the utility cart having the spool support assembly according to an example embodiment;

FIG. 8 illustrates a partially exploded perspective view showing how the spool support assembly operably couples to the utility cart according to an example embodiment;

FIG. 9 illustrates a close up view showing how the post member operably couples to the accessory slot according to an example embodiment;

FIG. 10 illustrates a close up view showing how the cross rod operably couples to the post member with a pin according to an example embodiment;

FIG. 11 illustrates a top view of the utility cart in accordance with an example embodiment;

FIG. 12 illustrates a close up view of the utility cart taken from box 12 in FIG. 11 in accordance with an example embodiment;

FIG. 13 illustrates an isolated perspective view of the post member in accordance with an example embodiment;

FIG. 14 illustrates a bottom perspective view of the post member in accordance with an example embodiment;

FIG. 15 illustrates a perspective view of the utility cart having a spool support assembly according to an example embodiment; and

FIG. 16 illustrates a perspective view of the utility cart having multiple spool support assemblies according to an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

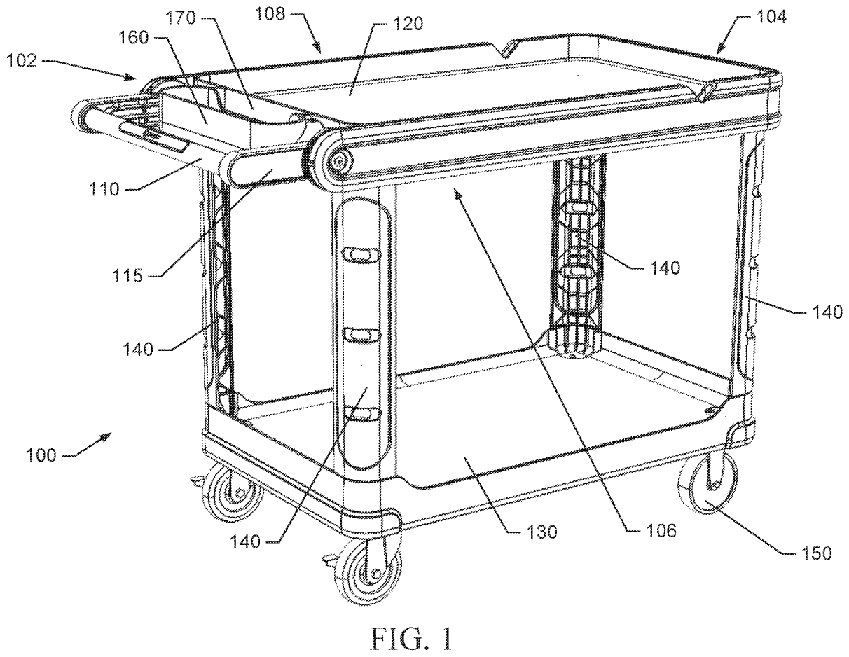

As indicated above, some example embodiments may relate to the provision of a utility cart 100 with an improved design. Referring now to FIG. 1, the utility cart 100 may include a handle 110, a top support platform 120, a bottom support platform 130, upright support members 140 and a mobility assembly. In some embodiments, the handle 110 may be a bar that may be disposed a distance away from the utility cart and may be operably coupled to the utility cart 100 at the top support platform 120 to allow for a user of the utility cart 100 to apply forces to move and steer the utility cart 100. When viewed from above, the utility cart 100 may have a substantially rectangular shape. In this regard, the utility cart 100 may have a first end 102 and a second end 104 and a first side 106 and a second side 108. The first end 102 and the second end 104 may both be equal to each other in length and shorter than each of the first side 106 and second side 108 of the utility cart 100. Thus, in some embodiments, the handle 110 may be operably coupled to the utility cart 100 at the first end 102 of the utility cart 100 proximate to the top support platform 120 so that the handle 110 may be at a comfortable position for the user of the utility cart 100 to interact with. The handle 110 of some example embodiments may also be adjustable. In this regard, the handle 110 may operably couple to the top support platform 120 via at least one extension arm 115. The at least one extension arm 115 may be pivotably operably coupled to the top support platform 120 such that an angle formed between the at least one extension arm 115 and the top support platform 120 may be adjustable. The handle 110 may therefore be fixed in whatever angle or position the user may desire via operable coupling of the at least one extension arm 115 to the top support platform 120.

The top support platform 120 may be disposed a distance above the bottom support platform 130 and supported by the upright support members 140. In some embodiments, there may be four total upright support members 140 supporting the top support platform 120, with one upright support member 140 disposed at each corner of the utility cart 100. It should be noted that in some other embodiments, more or fewer upright support members 140 may be used to support the top support platform 120. The top and bottom support platforms (120, 130) may both be planar surfaces substantially parallel to each other that may be capable of supporting objects thereon. In some cases, the top support platform 120 and the bottom support platform 130 may each include a lip that extends around the entire perimeter of each of the top and bottom support platforms (120, 130) that may help retain objects on respective support platforms by prohibiting the objects from rolling off the utility cart 100.

In some cases, some parts of the utility cart 100 may be formed from structural foam. In this regard, the top and bottom support platforms (120, 130), the handle 110, and some of the accessories described below may be formed from the structural foam. In some embodiments, the structural foam may be a black or gray color which may be a traditional appearance for many structural foams. The use of structural foam to construct the cart 100 may allow the cart 100 to achieve a higher stiffness-to-weight ratio than standard injection molded utility carts while also being more cost effective to produce. In some cases, products formed from structural foam may achieve a weight reduction of approximately 10-20% compared to their injection molded counterparts. However, the utility cart 100 of some embodiments may also include portions that are formed via an injection molding process. In this regard, the upright support members 140 may be injection molded from impact modified polypropylene, which may allow for the upright support members 140 to be colored without impacting the structural integrity of the cart 100.

Operably coupled to an underside of the bottom support platform 130 may be the mobility assembly, which may include a plurality of wheels 150. In some cases, the utility cart may include a total of four wheels 150, though more or less may also be used in other cases. The wheels 150 may be disposed at each of the four corners of the utility cart 100 shown in FIG. 1 in order to maximize the balance of the utility cart 100 and limit instability of the cart 100. In an example embodiment, all of the wheels 150 on the utility cart may be caster wheels. In such cases, all of the wheels 150 may be capable of turning 360° to allow the utility cart 100 to travel in any direction regardless of the orientation of the cart 100. In some other cases, the two wheels 150 disposed at the first end 102 may be caster wheels and the two wheels disposed at the second end 104 may be fixed wheels. In this regard, the utility cart 100 may be capable of being steered from the handle 110 at the first end 102 responsive to the caster wheels being capable of turning in any direction. In another example embodiment, the two wheels 150 disposed at the second end 104 may be caster wheels and the two wheels disposed at the first end 102 may be fixed wheels. In this regard, the utility cart 100 may be capable of being steered at the second end 104 via the handle 110 responsive to the caster wheels being capable of turning in any direction. In some cases, the wheels 150 may be fitted with a parking brake on each wheel 150. Each parking brake may immobilize the respective wheel 150 to which it may be operably coupled. With the parking brake for each wheel 150 engaged, the utility cart 100 may be held in place and may not roll anywhere. This feature may be useful when work may be done on the utility cart 100 itself, or in other cases where the cart 100 may roll away from the user unintentionally.

In some embodiments, the utility cart 100 may further include a storage pocket 160. The storage pocket 160 may be disposed between the handle 110 and the top support platform 120 in order to be easily accessible by the user of the utility cart 100. The storage pocket 160 may be capable of storing a number of objects of many different varieties. For example, the storage pocket 160 may store hand tools, writing utensils, or other miscellaneous objects of similar sizes. The storage pocket 160 may be disposed a distance away from the handle 110 due to the extension arms 115 extending away from the top support platform 120. In some cases, the distance between the handle 110 and the storage pocket 160 may vary since the position of the handle 110 may be adjustable. The storage pocket 160 may be disposed between two extension arms 115 of the handle 110. In this regard, there may be excess space on either longitudinal end of the storage pocket 160 between the storage pocket 160 and the extension arms 115. This space may provide some buffer between the storage pocket 160 and the extension arms 115 so that any objects stored in the storage pocket 160 do not interfere with the adjustment of the position of the handle 110 via the extension arms 115. In some cases, the space between the longitudinal ends of the storage pocket 160 and the extension arms 115 may account for approximately 10% of the total length of the handle 110, or a total distance between the two extension arms 115. In other words, the storage pocket 160 may have a length that is approximately 90% of the total length of the handle 110, or the total distance between the two extension arms 115.

The utility cart 100 may further include a technology receptacle 170 disposed between the storage pocket 160 and the top support platform 120. The technology receptacle 170 may be designed to support a personal electronic device, such as a mobile phone device or a tablet device, in a position where the personal electronic device may be used or viewed by the user of the utility cart 100. As such, the technology receptacle 170 may keep the personal electronic device separate from the storage of other objects within the storage pocket 160 to prevent any interference of the personal electronic device due to objects in the storage pocket 160. In contrast with the technology receptacle 170, the storage pocket 160 may be designed to hold a variety of tools, materials and objects that the user may want to keep separate or more accessible than objects in either of the top or bottom support platforms (120, 130). In an example embodiment, the distance between the storage pocket 160 and the handle 110 may not exceed a width of the storage pocket 160 measured between a shared wall with the technology receptacle 170 and a front wall of the storage pocket 160 closest to the handle 110. In some other cases, the distance between the storage pocket 160 and the handle 110 may be within a range of approximately 50-75% of the width of the storage pocket 160. This may ensure that there is sufficient space between the storage pocket 160 and the handle so that they may not interfere with each other as the user may interact with the handle 110 or the storage pocket 160. In an example embodiment, the technology receptacle 170 may have an overall length that is approximately 75% of the length of the storage pocket 160. In other words, the overall length of the technology receptacle 170 may be approximately 50-60% of the total length of the handle 110, or the total distance between the two extension arms 115. In an example embodiment, the top support platform 120 may be wider than the handle 110 is long. In other words, the length of the handle 110 may be approximately 90% of a width of the top support platform 120. Similarly, the length of the technology receptacle 170 may be approximately 40-50% of the width of the top support platform 120.

Thus, the technology receptacle 170 may hold the user's personal electronic device therein. For example, in a scenario where the utility cart 100 may be used for order fulfillment situations, the personal electronic device may contain a list of items needed to fulfill a particular order. Thus, the user of the cart 100 may need to easily see the screen of the personal electronic device being supported in the technology receptacle 170. In this regard, the technology receptacle 170 may provide stability of the personal electronic device disposed in the technology receptacle 170 so that the movement of the utility cart 100 does not knock over the personal electronic device. Additionally, the technology receptacle 170 may be designed to provide the user with an ergonomic view of the display of the personal electronic device so that the user of the utility cart 100 does not need to strain to view the device.

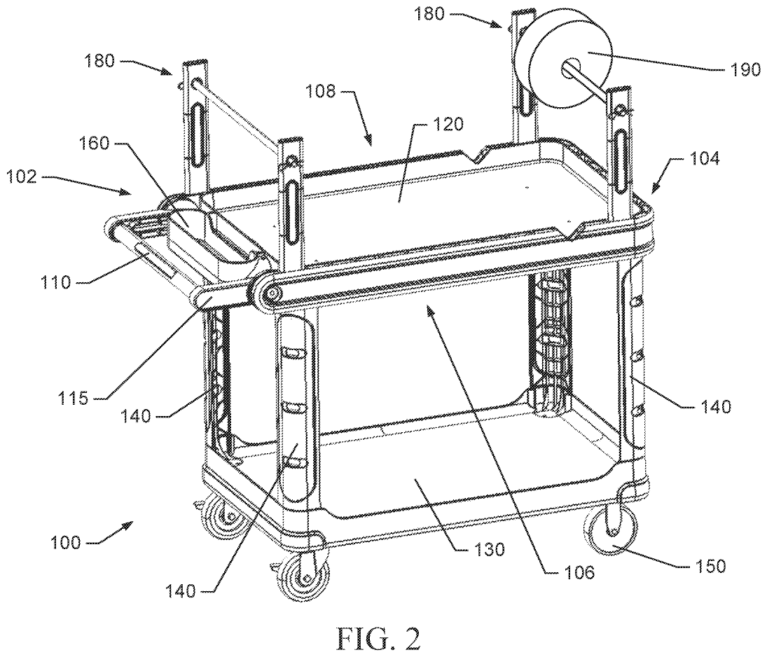

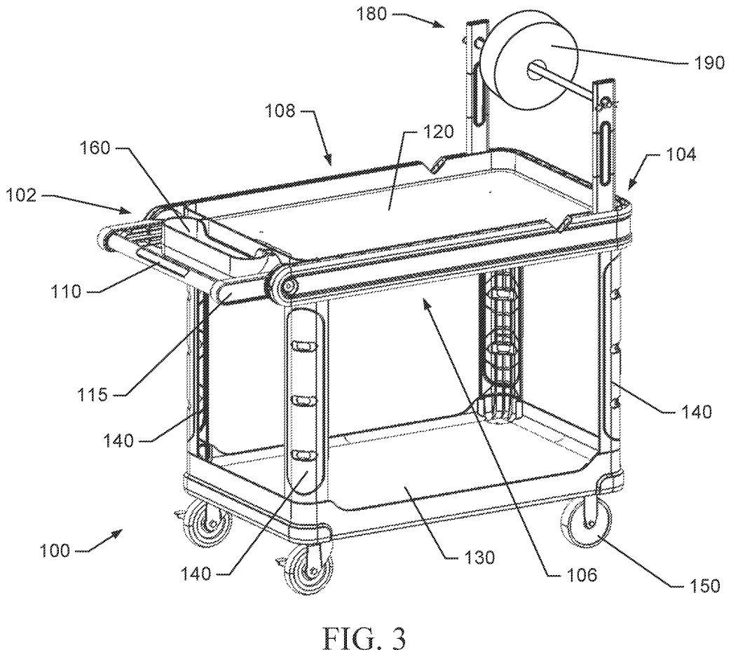

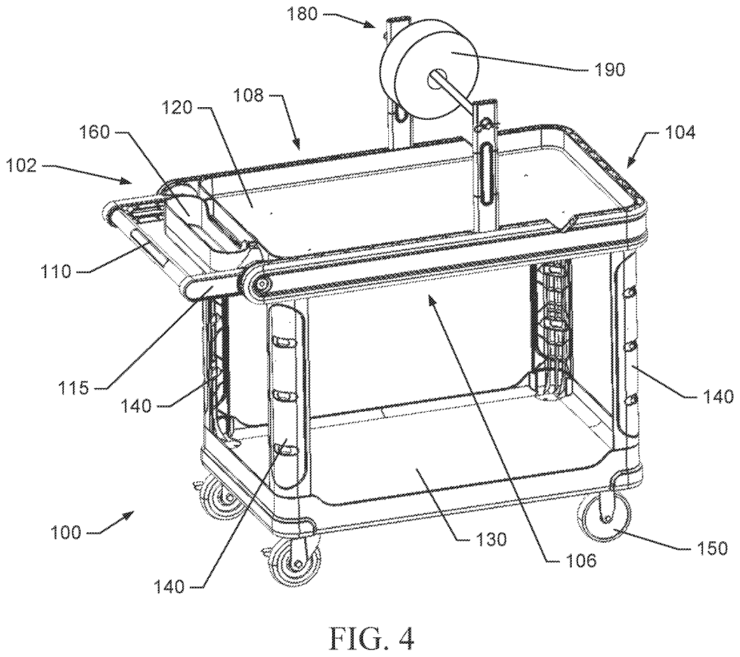

FIGS. 2-4 illustrate perspective views of the utility cart 100 in accordance with respective example embodiments. The utility cart 100 of FIG. 2 is depicted with two spool support assemblies 180 operably coupled to the utility cart 100 at the top support platform 120 simultaneously. In this regard, the spool support assemblies 180 may rotatably support one or more spools 190 of material such that the one or more spools 190 may have freedom to rotate relative to the respective spool support assembly 180 by which the spool 190 may be supported. Thus, in some cases, the utility cart 100 may include more than one spool support assembly 180. In example embodiments, the utility cart 100 may include, one, two, three, four, five, etc. spool support assemblies 180. The number of spool support assemblies 180 that are disposed on the utility cart 100 may in some cases be limited by the amount of available space on the utility cart 100 for the spool support assemblies 180. Thus, FIG. 3 depicts an example embodiment of the utility cart 100 in which only one spool support assembly 180 may be operably coupled to the utility cart 100. In some cases, such as the embodiment shown in FIG. 4, the spool support assembly 180 may be operably coupleable to the utility cart 100 at a plurality of locations on the utility cart 100. Thus, depending on the specific preferences of the user, the spool support assembly 180 may be moved to a number of potential locations on the utility cart 100 as desired. In an example embodiment, depending on the weight of the spools 190 operably coupled to the spool support assembly 180, the spool support assembly 180 may be moved to maintain a proper weight distribution on the cart 100 so that the cart 100 may not become unstable due to the spools 190 rotatably supported in the spool support assembly 180.

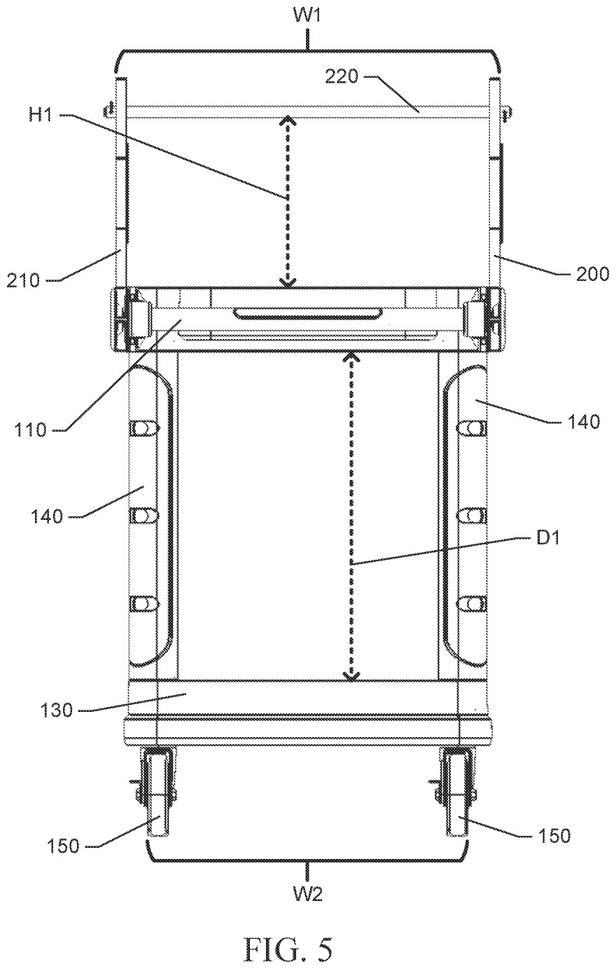

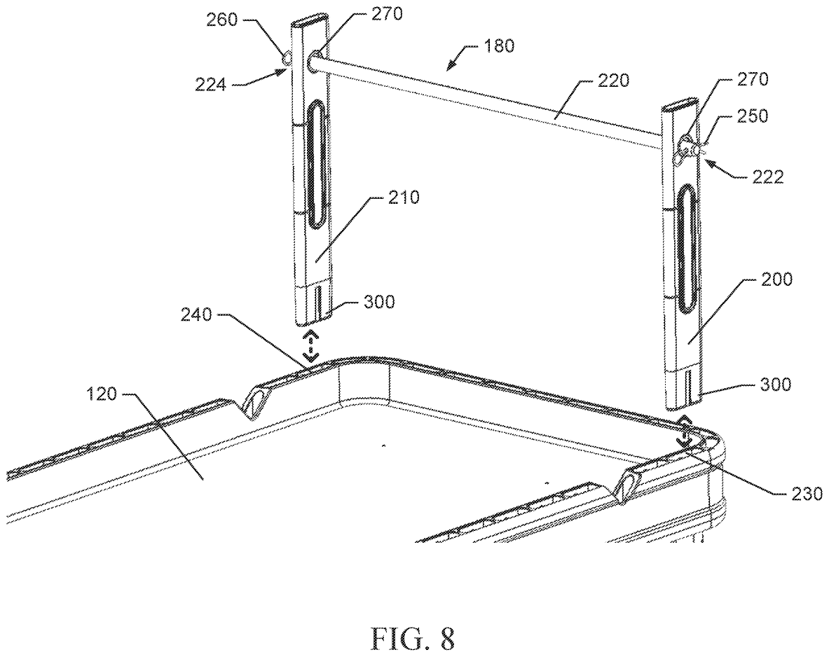

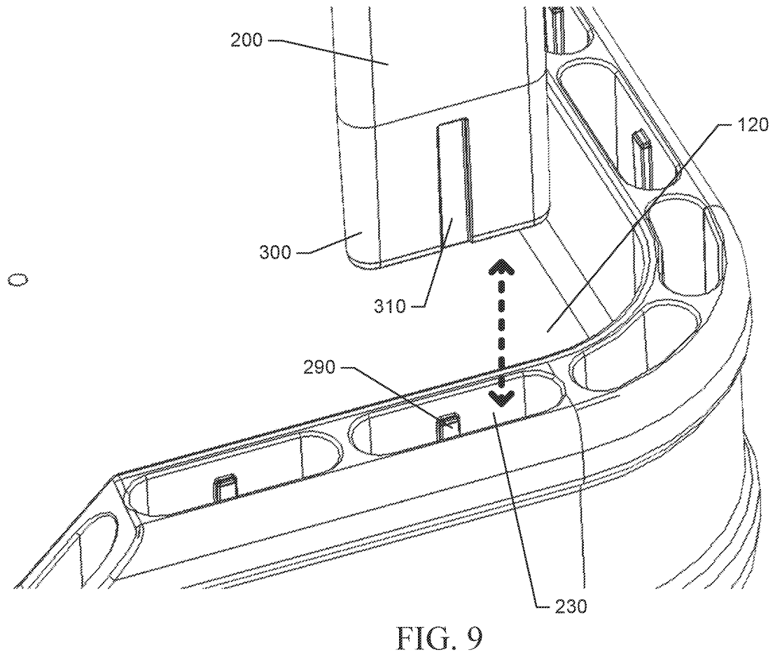

Referring now to FIGS. 5-10, according to some example embodiments, the spool support assembly 180 may include a first post member 200, a second post member 210, and a cross rod 220. The first post member 200 may be operably coupleable to the top support platform 120 via a first accessory slot 230 which may be formed at a perimeter of the top support platform 120, and the second post member 210 may be operably coupleable to the top support platform 120 via a second accessory slot 240 which may be formed at the perimeter of the top support platform 120. In some cases, the second post member 210 may be disposed on an opposing side of the top support platform 120 relative to the first post member 200. In other words, the first post member 200 may be disposed in the first accessory slot 230 at the first side 106 of the utility cart 100 while the second post member 210 may be disposed in the second accessory slot 240 at the second side 108 of the utility cart 100. Each of the first and second post members (200, 210) may extend substantially upright relative to, or vertically away from, the top support platform 120. In some cases, the cross rod 220 may extend laterally across a width of the top support platform 120, and between the first post member 200 and the second post member 210 to support the one or more spools 190 thereon. In this regard, the cross rod 220 may operably couple to respective top ends of the first and second post members (200, 210) at each end of the cross rod 220. Thus, in the example embodiment shown in FIGS. 5-10, the spool support assembly 180 may be configured to support the plurality of spools 190 above the top support platform 120. In this regard, by supporting the spools 190 above the top support platform 120, the spools 190 may be disposed in a position that may be more ergonomically accessible by the user of the utility cart 100. As such, it may be easier for the user to unspool, measure, and cut the material contained on the plurality of spools 190 when the spools 190 are supported above the top support platform 120. In an example embodiment, the first and second post members (200, 210) may be formed from a plastic and/or polymer material through an injection molding process. In some cases, the cross rod 220 may be formed from steel, a steel alloy, or another metallic material capable of rotatably supporting the plurality of spools 190.

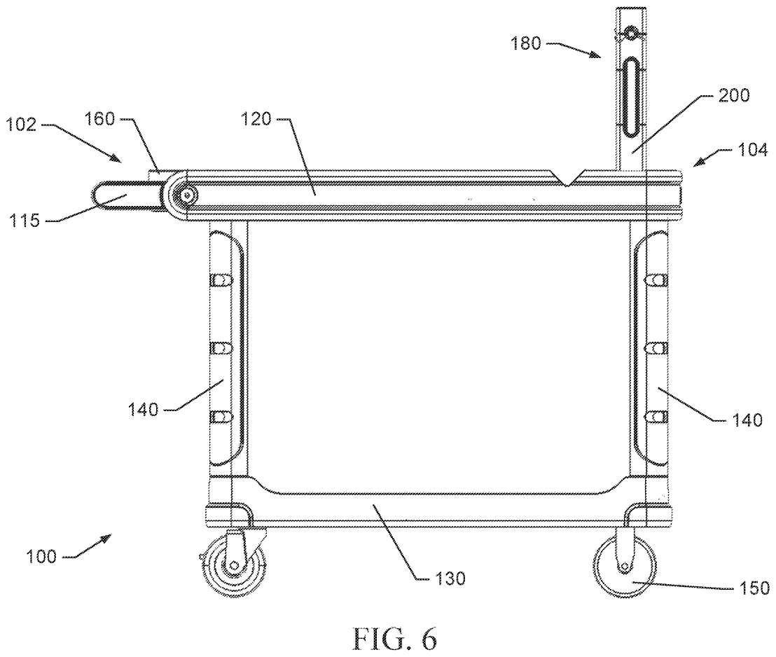

As shown in FIGS. 5 and 6, and as discussed above, the cross rod 220 of the spool support assembly 180 may be disposed at a height that may be ergonomically desirable for working with spools 190 of material. However, the spool support assembly 180 may not extend so far from the top support platform 120 that the center of gravity of the utility cart 100 is raised too high and the utility cart 100 is more unstable. In this regard, the cross rod 220 may be disposed a distance above the top support platform 120 that may be approximately equal to 50% of a distance between the top support platform 120 and the bottom support platform 130. In other words, the height (H1) of the spool support assembly 180 may be approximately equal to half of a distance (D1) between the top support platform 120 and the bottom support platform 130. In this regard, this ratio of the height of the spool support assembly 180 to the distance between the top support platform 120 and the bottom support platform 130 may help keep the center of gravity of the utility cart 100 low enough to maintain the stability of the cart 100 while the user may pull material off of the plurality of spools 190. On the other hand, the height (H1) of the spool support assembly 180 may at least be high enough to accommodate the plurality of spools 190 above the top support platform 120. For example, if the plurality of spools 190 were to have a diameter of approximately 16 inches, then the spool support assembly 180 should be high enough so that the cross rod 220 may be at least 8 inches above the top support platform 120 to permit the spools 190 to rotate on the cross rod 220.

Furthermore, the center of gravity of the cart 100 can effectively be lowered by the spool support assembly 180 having a larger width. In this regard, the first and second accessory slots (230, 240) to which the first and second post members (200, 210) operably couple may be disposed on the perimeter of the top support platform 120 as mentioned above. In this regard, the first and second accessory slots (230, 240) may be disposed at a maximum width of the top support platform 120. In some cases, this width (W1) may be wider than a width (W2) of the mobility assembly, which may be measured between the outermost edge of two consecutive wheels 150 of the mobility assembly. In other words, the first and second accessory slots (230, 240) may be disposed within the range of 30-40 mm outside the outermost edge of each wheel 150, and thus outside the width of the mobility assembly. In fact, in some cases, the horizontal distance between an outermost edge of the wheel 150 and the first post member 200 disposed at the same side of the cart 100 may be approximately 35 mm. In an example embodiment, the width (W2) of the mobility assembly may be approximately 90% of the width (W1) of the spool support assembly 180 measured between the first and second post members (200, 210). In this regard, maximizing the width (W1) of the spool support assembly 180 may help lower the center of gravity of the utility cart 100 and increase the overall stability of the cart 100. Increasing the stability of the cart 100 may reduce the likelihood of the cart 100 tipping or leaning or moving due to having spools 190 supported on the spool support assembly 180 or due to a user pulling material off of spools 190 supported on the spool support assembly 180.

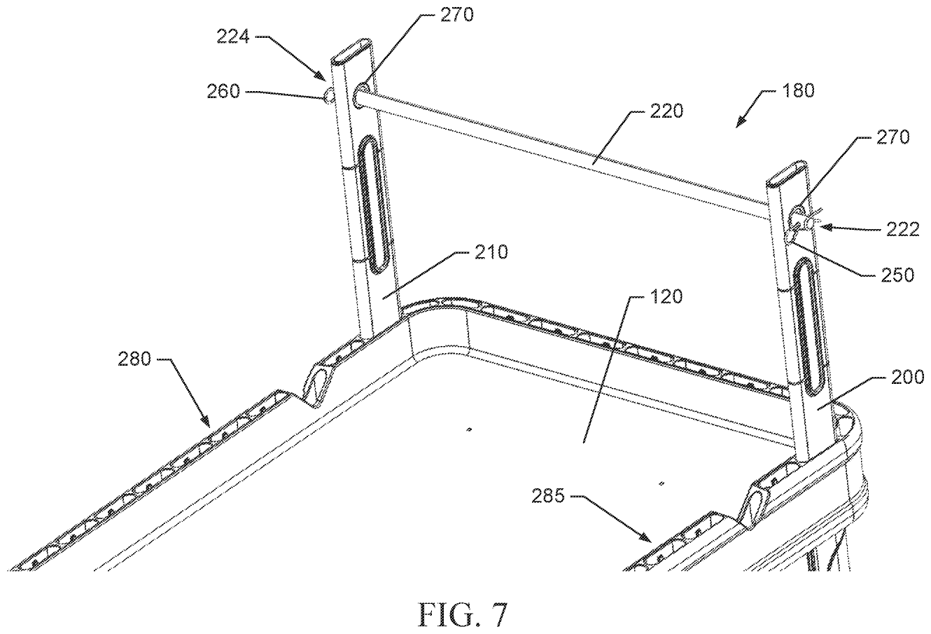

As seen in FIGS. 7-10, the spool support assembly 180 may further include a first pin 250 which may be operably coupled to a first end 222 of the cross rod 220 and a second pin 260 operably coupled to a second end 224 of the cross rod 220. In this regard, the first pin 250 may operably couple the cross rod 220 to the first post member 200 and the second pin 260 may operably couple the cross rod 220 to the second post member 210. In an example embodiment, the first and second pins (250, 260) may be a hairpin type clip which may be inserted through a bore disposed through the cross rod 220, along a diameter of the cross rod 220, and proximate to both the first and second ends (222, 224) of the cross rod 220. Thus, to assemble the spool support assembly 180 on the utility cart 100, a user may first insert the first and second post members (200, 210) into the respective first and second accessory slots (230, 240) in any order. Responsive to the first and second post members being operably coupled to the utility cart 100, the cross rod 220 may be inserted perpendicular to the first and second post members (200, 210) through a receiving orifice 270 disposed proximate to the top end of each of the first and second post members (200, 210). Responsive to the cross rod 220 being disposed in the respective receiving orifices of the first and second post members (200, 210), then the first and second pins (250, 260) may be inserted into the respective bores disposed at the first and second ends (222, 224) of the cross rod 220. In order to add or remove a spool 190 to the spool support assembly 180, the user may simply need to remove one of the first and second pins (250, 260) and slide the cross rod 220 out of one of the first and second post members (200, 210). In this regard, one of the first and second ends (222, 224) of the cross rod 220 may be disposed between the first and second post members (200, 210). This may allow the user to slide a spool 190 over the end of the cross rod 220 that is disposed between the first and second post members (200, 210) such that the cross rod 220 may extend through a center of rotation of the spool 190. Responsive to the spool 190 being added to the cross rod 220, the cross rod 220 may be reinserted through the respective post member (200, 210) from which it was previously removed and then the respective pin (250, 260) that was previously removed may be reinserted into the bore.

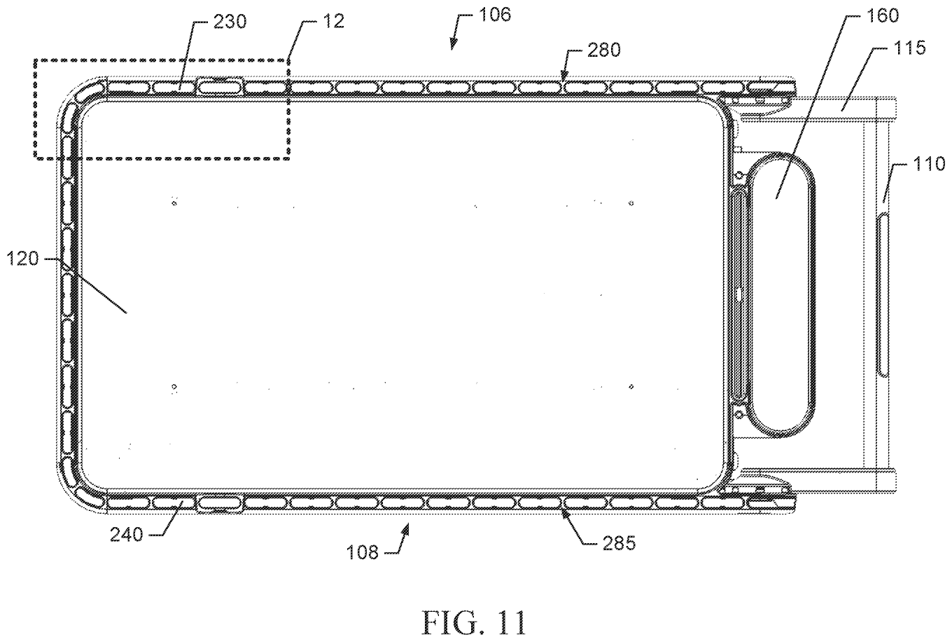

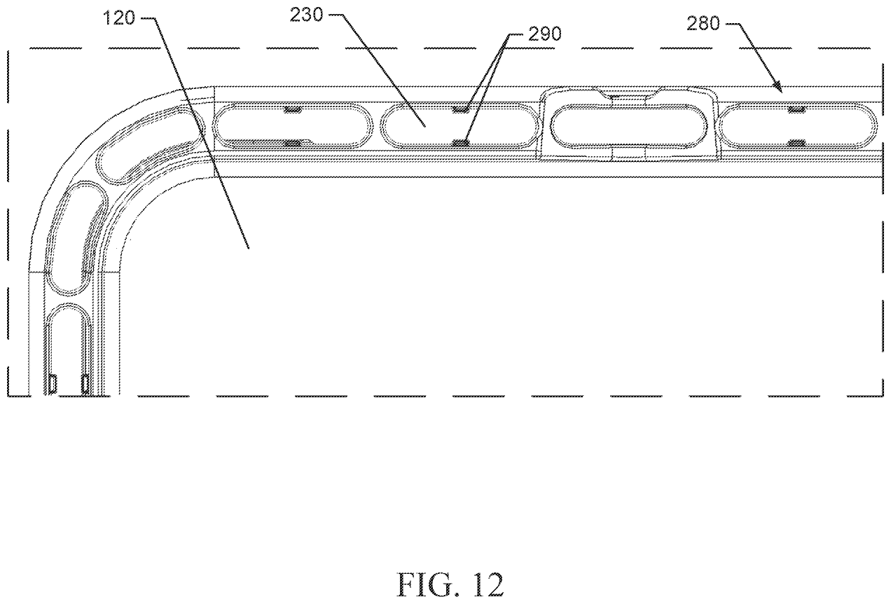

FIGS. 11 and 12 depict the utility cart 100 and the top support platform 120 having numerous accessory slots disposed around a perimeter of the top support platform 120. In this regard, the first accessory slot 230 may be one accessory slot of a first plurality of accessory slots 280 that may be disposed along the first side 106 of the cart 100. Similarly, the second accessory slot 240 may be one accessory slot of a second plurality of accessory slots 285 that may be disposed along the second side 108 of the cart 100. Thus, the top support platform 120 may be lined with the first and second pluralities of accessory slots (280, 285) on opposing sides of the perimeter of the top support platform 120. In some cases, individual ones of the second plurality of accessory slots 285 may mirror respective ones of the first plurality of accessory slots 280. As such, the spool support assembly 180 may be operably coupled to the top support platform 120 via the first and second accessory slots (230, 240) which may be a mirrored pair of accessory slots from the first and second pluralities of accessory slots (280, 285), accordingly. In an example embodiment, the first and second ends (102, 104) of the perimeter of the top support platform 120 may also include accessory slots disposed therein. In some cases, the spool support assembly 180 may be operably coupled to the utility cart 100 such that the cross rod 220 may be parallel with a longitudinal axis of the utility cart 100 extending from the first end 102 to the second end 104 and parallel with the first and second sides (106, 108) of the cart 100. In such cases, the cross rod 220 may be longer to extend the length of the top support platform 120 between the first and second post members (200, 210).

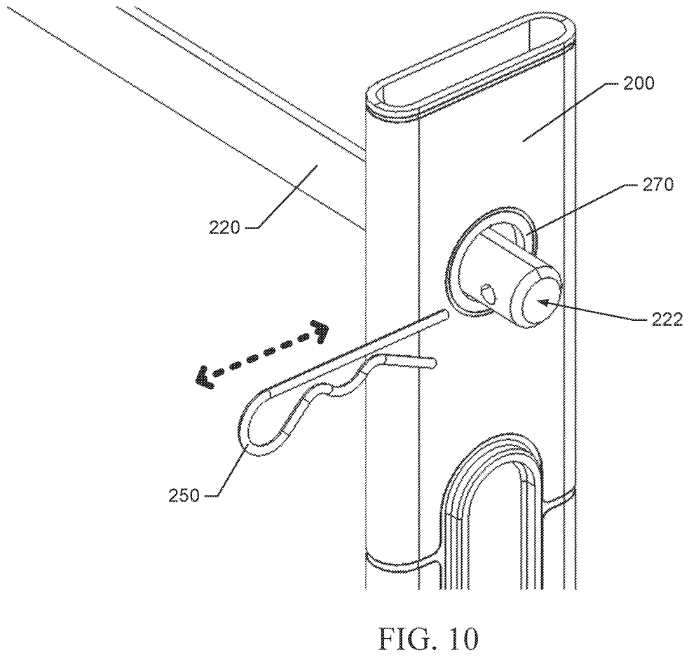

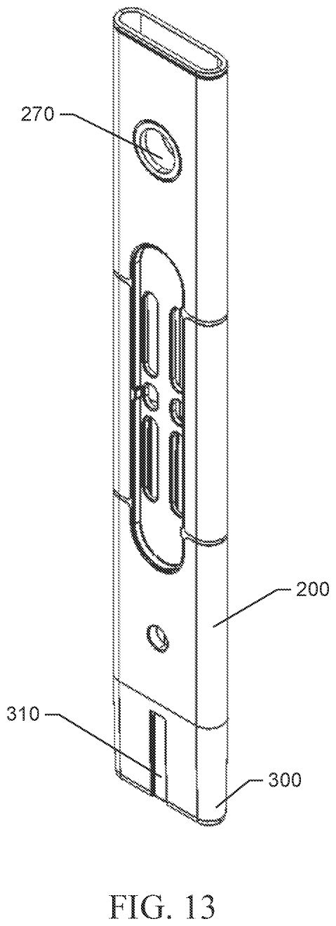

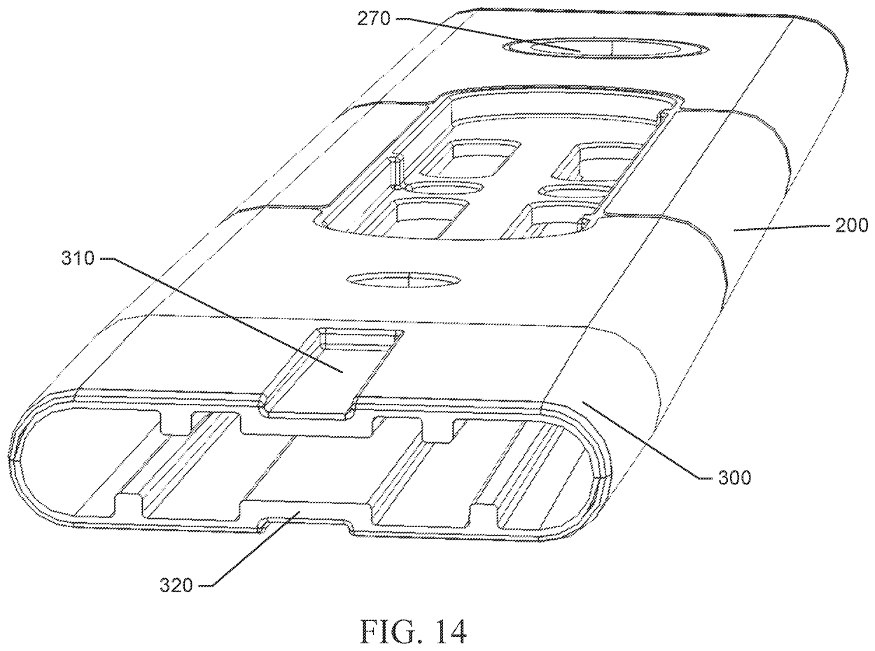

As shown in FIGS. 10 and 11, the first and second accessory slots (230, 240) may be substantially discorectangular in shape (e.g. racetrack or rounded rectangle) and may include a protrusion 290 disposed at a midpoint of each planar side of the accessory slots (230, 240). The protrusion 290 may extend into an empty interior region of the first and second accessory slots (230, 240) and may help to not only align the first and second post members (200, 210) with the first and second accessory slots (230, 240), respectively, but may also help to lock the first and second post members (200, 210) in place and not let them extend through the bottom of the first and second accessory slots (230, 240), respectively. In this regard, as shown in FIGS. 13 and 14, the first and second post members (200, 210) may include a base portion 300 which may be shaped complimentarily to the first and second accessory slots (230, 240) to permit the removable operable coupling between the first and second post members (200, 210) and the first and second accessory slots (230, 240), respectively, by hand. In other words, the first post member 200 may be installed into, and removed from, the first accessory slot 230 by hand and without the use of any tools. Similarly, the second post member 210 may be installed into, and removed from, the second accessory slot 240 by hand and without the use of any tools. In some cases, the first and second post members (200, 210) may be identical to one another. In this regard, the first and second post members (200, 210) may be operably coupled to any of the accessory slots in the first and second pluralities of accessory slots (280, 285). As seen in FIGS. 13 and 14, the base portion 300 of the first and second post members (200, 210) may be substantially discorectangular in shape and may include first and second grooves (310, 320) which may be disposed at a midpoint of each planar side of the first and second post members (200, 210). The protrusions 290 disposed within the first and second accessory slots (230, 240) may engage with the first and second grooves (310, 320) of each of the first and second post members (200, 210) to operably couple the respective one of the first and second post members (200, 210) to the respective accessory slot (230, 240). At an opposite end of the first and second post members (200, 210) from the base portion 300, the receiving orifice 270 may extend through the post member (200, 210) in order to permit the cross rod 220 to operably couple thereto.

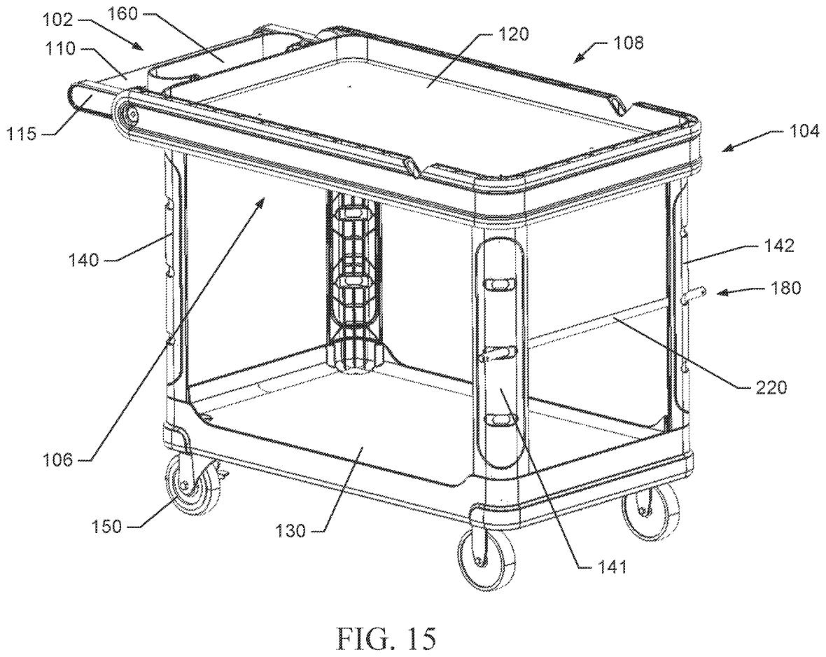

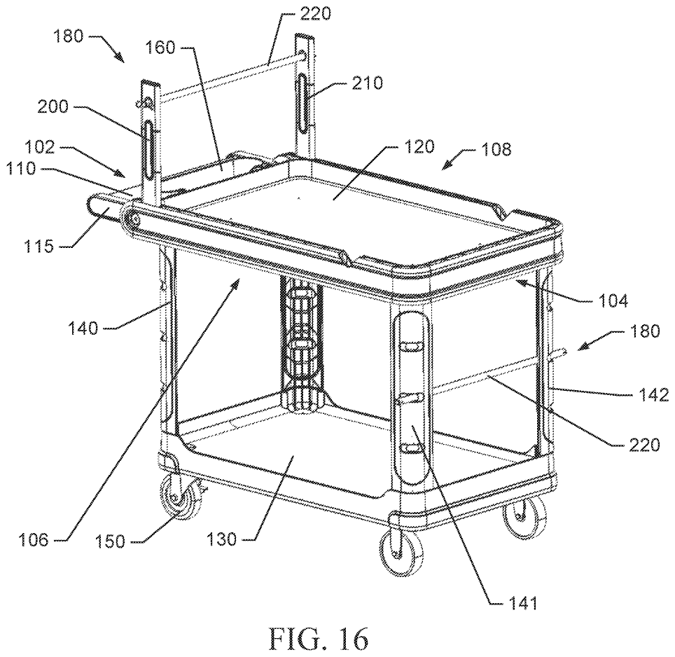

In some cases, such as those shown in FIGS. 15 and 16, the spool support assembly 180 may include a first upright support member 141 of the plurality of upright support members 140, a second upright support member 142 of the plurality of upright support members 140, and the cross rod 220 extending laterally between the first upright support member 141 and the second upright support member 142 to support the one or more spools 190 between the top support platform 120 and the bottom support platform 130. In this regard, the plurality of upright support members 140 may be formed having a plurality of holes disposed in each of the upright support members 140. The holes may be formed perpendicularly through the upright support members 140 with respect to the direction of extension of the upright support members 140. Similar to the first and second pluralities of accessory slots (280, 285), the holes in the upright support members 140 may mirror each other so that the cross rod 220 may extend between the first and second upright support members (141, 142) and be level so that the spools 190 do not slide towards a single end of the cross rod 220.

In some example embodiments, the utility cart 100 may include an accessory support assembly 330. In this regard, the accessory support assembly 330 may include the handle 110, the top support platform 10 of the utility cart 100, the bottom support platform 130 of the utility cart 100, the plurality of upright support members 140 which may operably couple the bottom support platform 130 to the top support platform 120, and the spool support assembly 180 which may be removably operably coupled to the utility cart 100. The spool support assembly 180 may be configured to rotatably support the one or more spools 190 such that the one or more spools 190 may have freedom to rotate relative to the spool support assembly 180. The accessory support assembly 330 may be configured to retain additional accessories for the utility cart 100 therein or otherwise operably couple to additional accessories for the utility cart 100.

Some example embodiments may provide for a utility cart. The utility cart may include a handle, a top support platform, to which the handle may be operably coupled, a bottom support platform which may be parallel to the top support platform, a plurality of upright support members which may operably couple the bottom support platform to the top support platform, a mobility assembly which may be operably coupled to the bottom support platform, and a spool support assembly which may be removably operably coupled to the utility cart. The spool support assembly may be configured to rotatably support one or more spools such that the one or more spools may have freedom to rotate relative to the spool support assembly.

The utility cart of some embodiments may include additional, optional features, and/or the features described above may be modified or augmented. Some examples of modifications, optional features and augmentations are described below. It should be appreciated that the modifications, optional features and augmentations listed below may each be added alone, or they may be added cumulatively in any desirable combination. For example, in some embodiments, the spool support assembly may include a first post member which may be operably coupleable to the top support platform via a first accessory slot which may be formed at a perimeter of the top support platform, a second post member which may be operably coupleable to the top support platform via a second accessory slot which may be formed at the perimeter of the top support platform, the second post member may be disposed on an opposing side of the top support platform relative to the first post member, and a cross rod which may extend laterally across a width of the top support platform and may be disposed between the first post member and the second post member to support the one or more spools. In some cases, the spool support assembly may be configured to support the plurality of spools above the top support platform. In an example embodiment, the cross rod may be disposed a distance above the top support platform that may be approximately equal to 50% of a distance between the top support platform and the bottom support platform. In some cases, the first and second accessory slots may be disposed within the range of 30-40 mm outside a width of the mobility assembly. In an example embodiment, the width of the mobility assembly may be approximately 90% of a width of the spool support assembly. In some cases, the first accessory slot may be one of a first plurality of accessory slots which may be disposed along a first side of the top support platform and the second accessory slot may be one of a second plurality of accessory slots which may be disposed along a second side of the top support platform. In an example embodiment, individual ones of the second plurality of accessory slots may mirror respective ones of the first plurality of accessory slots. In some cases, the first and second post members may include a base portion shaped complimentarily to the first and second accessory slots to permit removable operable coupling between the first and second post members and the first and second accessory slots, respectively, by hand. In an example embodiment, the spool support assembly may further include a first pin which may be operably coupled to a first end of the cross rod to operably couple the cross rod to the first post member, and a second pin which may be operably coupled to a second end of the cross rod to operably couple the cross rod to the second post member. In some cases, the utility cart may include a first spool support assembly and a second spool support assembly simultaneously operably coupled to the top support platform. In an example embodiment, the spool support assembly may include a first upright support member of the plurality of upright support members, a second upright support member of the plurality of upright support members, and a cross rod extending laterally between the first upright support member and the second upright support member to support the one or more spools between the top support platform and the bottom support platform.

Some example embodiments may provide for an accessory support assembly for a utility cart. The accessory support assembly may include a handle, a top support platform of the utility cart, a bottom support platform of the utility cart, the bottom support platform may be disposed substantially parallel to the top support platform, a plurality of upright support members which may operably couple the bottom support platform to the top support platform, and a spool support assembly which may be removably operably coupled to the utility cart. The spool support assembly may be configured to rotatably support one or more spools such that the one or more spools may have freedom to rotate relative to the spool support assembly.

Some example embodiments may provide for a spool support assembly for removable operable coupling to a utility cart. The spool support assembly may include a first post member which may be operably coupleable to a top support platform of the utility cart via a first accessory slot which may be formed at a perimeter of the top support platform, a second post member which may be operably coupleable to the top support platform via a second accessory slot which may be formed at the perimeter of the top support platform, the second post member may be disposed on an opposing side of the top support platform relative to the first post member, and a cross rod which may extend laterally across a width of the top support platform and may be disposed between the first post member and the second post member to support the one or more spools. The spool support assembly may be configured to support the plurality of spools above the top support platform.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

That which is claimed:

1. A utility cart comprising:
a handle;
a top support platform, to which the handle is operably coupled;
a bottom support platform disposed parallel to the top support platform;
a plurality of upright support members operably coupling the bottom support platform to the top support platform;
a mobility assembly operably coupled to the bottom support platform; and
a spool support assembly removably operably coupled to the utility cart,
wherein the spool support assembly is configured to rotatably support one or more spools such that the one or more spools have freedom to rotate relative to the spool support assembly.

2. The utility cart of claim 1, wherein the spool support assembly comprises:
a first post member operably coupleable to the top support platform via a first accessory slot formed at a perimeter of the top support platform;
a second post member operably coupleable to the top support platform via a second accessory slot formed at the perimeter of the top support platform, the second post member being disposed on an opposing side of the top support platform relative to the first post member; and
a cross rod extending laterally across a width of the top support platform disposed between the first post member and the second post member to support the one or more spools,
wherein the spool support assembly is configured to support the one or more spools above the top support platform.

3. The utility cart of claim 2, wherein the cross rod is disposed a distance above the top support platform that is approximately equal to 50% of a distance between the top support platform and the bottom support platform.

4. The utility cart of claim 2, wherein the first and second accessory slots are disposed within a range of 30-40 mm outside a width of the mobility assembly.

5. The utility cart of claim 4, wherein the width of the mobility assembly is approximately 90% of a width of the spool support assembly.

6. The utility cart of claim 2, wherein the first accessory slot is one of a first plurality of accessory slots disposed along a first side of the top support platform and the second accessory slot is one of a second plurality of accessory slots disposed along a second side of the top support platform, and
wherein individual ones of the second plurality of accessory slots mirror respective ones of the first plurality of accessory slots.

7. The utility cart of claim 2, wherein the first and second post members comprise a base portion shaped complimentarily to the first and second accessory slots to permit removable operable coupling between the first and second post members and the first and second accessory slots, respectively, by hand.

8. The utility cart of claim 2, wherein the spool support assembly further comprises:
a first pin operably coupled to a first end of the cross rod to operably couple the cross rod to the first post member; and
a second pin operably coupled to a second end of the cross rod to operably couple the cross rod to the second post member.

9. The utility cart of claim 1, wherein the utility cart comprises a first spool support assembly and a second spool support assembly simultaneously operably coupled to the top support platform.

10. The utility cart of claim 1, wherein the spool support assembly comprises:
a first upright support member of the plurality of upright support members;
a second upright support member of the plurality of upright support members; and
a cross rod extending laterally between the first upright support member and the second upright support member to support the one or more spools between the top support platform and the bottom support platform.

11. An accessory support assembly for a utility cart, the accessory support assembly comprising:
a top support platform of the utility cart;
a bottom support platform of the utility cart, the bottom support platform disposed substantially parallel to the top support platform;
a plurality of upright support members operably coupling the bottom support platform to the top support platform; and
a spool support assembly removably operably coupled to the utility cart,
wherein the spool support assembly is configured to rotatably support one or more spools such that the one or more spools have freedom to rotate relative to the spool support assembly.

12. The accessory support assembly of claim 11, wherein the spool support assembly comprises:
a first post member operably coupleable to the top support platform via a first accessory slot formed at a perimeter of the top support platform;
a second post member operably coupleable to the top support platform via a second accessory slot formed at the perimeter of the top support platform, the second post member being disposed on an opposing side of the top support platform relative to the first post member; and
a cross rod extending laterally across a width of the top support platform disposed between the first post member and the second post member to support the one or more spools,
wherein the spool support assembly is configured to support the one or more spools above the top support platform.

13. The accessory support assembly of claim 12, wherein the cross rod is disposed a distance above the top support platform that is approximately equal to 50% of a distance between the top support platform and the bottom support platform.

14. The accessory support assembly of claim 12, wherein the first accessory slot is one of a first plurality of accessory slots disposed along a first side of the top support platform and the second accessory slot is one of a second plurality of accessory slots disposed along a second side of the top support platform, and
wherein individual ones of the second plurality of accessory slots mirror respective ones of the first plurality of accessory slots.

15. The accessory support assembly of claim 12, wherein the first and second post members include a base portion shaped complimentary to the first and second accessory slots to enable removable coupling between the first and second post members and the first and second accessory slots, respectively, by hand.

16. The accessory support assembly of claim 12, wherein the spool support assembly further comprises:
a first pin operably coupled to a first end of the cross rod to operably couple the cross rod to the first post member; and
a second pin operably coupled to a second end of the cross rod to operably couple the cross rod to the second post member.

17. The accessory support assembly of claim 11, wherein the spool support assembly comprises:
a first upright support member of the plurality of upright support members;
a second upright support member of the plurality of upright support members;
a cross rod extending laterally between the first upright support member and the second upright support member to support the one or more spools between the top support platform and the bottom support platform.

18. A spool support assembly for removable operable coupling to a utility cart, the spool support assembly comprising:
a first post member operably coupleable to a top support platform of the utility cart via a first accessory slot formed at a perimeter of the top support platform;
a second post member operably coupleable to the top support platform via a second accessory slot formed at the perimeter of the top support platform, the second post member being disposed on an opposing side of the top support platform relative to the first post member; and
a cross rod extending laterally across a width of the top support platform disposed between the first post member and the second post member to support the one or more spools,
wherein the spool support assembly is configured to support the one or more spools above the top support platform.

19. The spool support assembly of claim 18, wherein the spool support assembly further comprises:
a first pin operably coupled to a first end of the cross rod to operably couple the cross rod to the first post member; and
a second pin operably coupled to a second end of the cross rod to operably couple the cross rod to the second post member.

20. The spool support assembly of claim 18, wherein the first and second post members include a base portion shaped complimentary to the first and second accessory slots to enable removable coupling between the first and second post members and the first and second accessory slots, respectively, by hand.
